(19) United States
(12) Patent Application Publication
(10) Pub. No.: US 2026/0071946 A1
(43) Pub. Date: Mar. 12, 2026

(54) DETERMINING A VISCOSITY OF A FLUID

(71) Applicant: MICRO MOTION, INC., Boulder, CO (US)

(72) Inventors: Anthony William PANKRATZ, Arvada, CO (US); Marcus J. SCHMIDT, Centennial, CO (US); Gregory Treat LANHAM, Longmont, CO (US)

(73) Assignee: MICRO MOTION, INC., Boulder, CO (US)

(21) Appl. No.: 19/109,668

(22) PCT Filed: Sep. 12, 2022
(86) PCT No.: PCT/US2022/043232

§ 371 Date: Mar. 7, 2025

(51) Int. Cl. G01N 11/04; G01N 11/00

(52) U.S. Cl. CPC G01N 11/04; G01N 2011/0073

(57) ABSTRACT

A method of determining a viscosity of a fluid is provided. The method comprises receiving one or more sensor signals from a sensor assembly containing a fluid to determine a fluid property of the fluid, determining, based on the one or more sensor signals, an energy dissipation value of the sensor assembly containing the fluid, and determining a viscosity value of the fluid based on the energy dissipation value.

### TECHNICAL FIELD

The embodiments described below relate to determining a property of a fluid and, more particularly, to determining a viscosity of a fluid.

### BACKGROUND

Vibratory meters, such as for example, Coriolis mass flowmeters, liquid density meters, gas density meters, liquid viscosity meters, gas/liquid specific gravity meters, gas/liquid relative density meters, and gas molecular weight meters, are generally known and are used for measuring fluid parameters. Generally, vibratory meters comprise a sensor assembly and a meter electronics. The material within the sensor assembly may be flowing or stationary. The vibratory meter may be used to measure the one or more fluid parameters such as mass flow rate, density, or other properties of a material in the sensor assembly.

The vibratory meter or, more particularly, the sensor assembly, may be in-line with a pipeline. More specifically, an inlet of the sensor assembly may be fluidly coupled to an inlet pipeline and an outlet of the sensor assembly may be fluidly coupled to an outlet pipeline. The sensor assembly typically includes one or more conduits, which may be referred to as flow tubes, that vibrate to measure the one or more fluid properties. The fluid properties are measured by using sensors coupled to the conduits that measure a displacement of the conduits.

The displacement of the conduits may be used to determine various fluid properties of the fluid, such as density, mass flow rate, etc. However, additional sensors may be required inside or outside the vibratory flow meter to determine other fluid properties. These other sensors may be undesirable due to costs, additional sources of failure modes or noise, etc. Accordingly, there is a need to determine additional fluid properties without employing additional sensors. With more particularity, there is a need to determine a viscosity of a fluid.

### SUMMARY

A method of determining a viscosity of a fluid is provided. According to an embodiment, the method comprises receiving one or more sensor signals from a sensor assembly containing a fluid to determine a fluid property of the fluid, determining, based on the one or more sensor signals, an energy dissipation value of the sensor assembly containing the fluid, and determining a viscosity value of the fluid based on the energy dissipation value.

A meter electronics for determining a viscosity of a fluid is provided. According to an embodiment, the meter electronics comprises an interface configured to receive one or more sensor signals from a sensor assembly containing the fluid, and provide the one or more sensor signals, a processing system communicatively coupled to the interface. The processing system is configured to receive the one or more sensor signals from the interface and perform the steps of the foregoing method steps.

A vibratory meter for determining a viscosity of a fluid is provided. According to an embodiment, the vibratory meter comprises a sensor assembly containing the fluid and configured to provide one or more sensor signals, and a meter electronics of the foregoing communicatively coupled to the sensor assembly.

A method of determining a viscosity of a fluid is provided. According to an embodiment, the method comprises determining energy dissipation values of a sensor assembly containing each fluid of a plurality of fluids having known viscosity values and determining an energy dissipation-viscosity relationship based on the energy dissipation values of the sensor assembly containing each fluid of the plurality of fluids and the known viscosity values of the plurality of fluids.

A meter electronics for determining a viscosity of a fluid is provided. According to an embodiment, the meter electronics comprises an interface configured to receive one or more sensor signals from a sensor assembly containing the fluid, and provide the one or more sensor signals, and a processing system communicatively coupled to the interface. The processing system is configured to receive the one or more sensor signals from the interface and perform the above steps.

A vibratory meter for determining a viscosity of a fluid is provided. According to an embodiment, the vibratory meter comprises a sensor assembly containing the fluid and configured to provide one or more sensor signals, and a meter electronics of the foregoing communicatively coupled to the sensor assembly.

### Aspects

According to an aspect, a method of determining a viscosity of a fluid comprises receiving one or more sensor signals from a sensor assembly containing a fluid to determine a fluid property of the fluid, determining, based on the one or more sensor signals, an energy dissipation value of the sensor assembly containing the fluid, and determining a viscosity value of the fluid based on the energy dissipation value.

Preferably, the energy dissipation value is a damping value of the sensor assembly.

Preferably, the damping value of the sensor assembly is comprised of at least a material damping of at least one conduit of the sensor assembly and a fluid damping of the fluid contained by the at least one conduit.

Preferably, receiving the one or more sensor signals from the sensor assembly comprises receiving a left pickoff sensor signal and a right pickoff sensor signal.

Preferably, receiving the one or more sensor signals from the sensor assembly comprises receiving a resonance frequency component and at least one non-resonance frequency component of the one or more sensor signals.

Preferably, the method further comprises providing a drive signal to the sensor assembly and determining a drive signal value.

Preferably, determining the energy dissipation value of the sensor assembly based on the one or more sensor signals comprises determining a frequency response function based on the one or more sensor signals and the drive signal provided to the sensor assembly.

Preferably, determining the frequency response function based on the one or more sensor signals and the drive signal provided to the sensor assembly comprises determining a ratio of an amplitude of the one or more sensor signals and an amplitude of the drive signal.

Preferably, determining the viscosity value of the fluid based on the energy dissipation value comprises obtaining an energy dissipation-viscosity relationship and determining the viscosity value of the fluid based on the energy dissipation-viscosity relationship and the energy dissipation value.

According to an aspect, a meter electronics for determining a viscosity of a fluid comprises an interface configured to receive one or more sensor signals from a sensor assembly containing the fluid, and provide the one or more sensor signals, a processing system communicatively coupled to the interface. The processing system is configured to receive the one or more sensor signals from the interface and perform the steps of the foregoing method steps.

According to an aspect, a vibratory meter for determining a viscosity of a fluid comprises a sensor assembly containing the fluid and configured to provide one or more sensor signals, and a meter electronics of the foregoing communicatively coupled to the sensor assembly.

According to an aspect, a method of determining a viscosity of a fluid comprises determining energy dissipation values of a sensor assembly containing each fluid of a plurality of fluids having known viscosity values and determining an energy dissipation-viscosity relationship based on the energy dissipation values of the sensor assembly containing each fluid of the plurality of fluids and the known viscosity values of the plurality of fluids.

Preferably, determining the energy dissipation-viscosity relationship comprises determining a relation between the energy dissipation values of the sensor assembly containing each fluid of the plurality of fluids and the viscosity values of the plurality of fluids.

Preferably, determining the relationship between the energy dissipation values of the sensor assembly containing each fluid of the plurality of fluids and the viscosity values of the plurality of fluids comprises determining at least one of a function and a set of ordered pairs that relate the energy dissipation values of the sensor assembly containing each fluid of the plurality of fluids and the viscosity values of the plurality of fluids.

Preferably, determining the energy dissipation-viscosity relationship based on the energy dissipation values of the sensor assembly containing each fluid of the plurality of fluids and the viscosity values of the plurality of fluids comprises determining a first energy dissipation value of a first fluid having a first viscosity value and a second energy dissipation value of the second fluid having a second viscosity value, and determining the energy dissipation-viscosity relationship based on at least the first viscosity value, the first energy dissipation value, the second viscosity value, and the second energy dissipation value.

Preferably, each of the energy dissipation values of the sensor assembly containing each fluid of the plurality of fluids represents an aggregate energy dissipation of the sensor assembly and a damping of each of the plurality of fluids contained by the sensor assembly.

According to an aspect, a meter electronics for determining a viscosity of a fluid comprises an interface configured to receive one or more sensor signals from a sensor assembly containing the fluid, and provide the one or more sensor signals, and a processing system communicatively coupled to the interface. The processing system is configured to receive the one or more sensor signals from the interface and perform the above steps.

According to an aspect, a vibratory meter for determining a viscosity of a fluid comprises a sensor assembly containing the fluid and configured to provide one or more sensor signals, and a meter electronics of the foregoing communicatively coupled to the sensor assembly.

### BRIEF DESCRIPTION OF THE DRAWINGS

The same reference number represents the same element on all drawings. It should be understood that the drawings are not necessarily to scale.

FIG. 1 shows a vibratory meter 5 configured to determine a viscosity of a fluid.

FIG. 2 shows a block diagram of the vibratory meter 5, including a block diagram representation of the meter electronics 20, configured to determine a viscosity of a fluid.

FIG. 3 shows a block diagram of the vibratory meter 5 with a frequency response function estimation for determining a viscosity of a fluid.

FIG. 4 shows a meter electronics 20 for determining a viscosity of a fluid.

FIG. 5 shows a stiffness measurement change plot 500 from meter verifications of a sensor assembly 10.

FIG. 6 shows energy dissipation change plot 600 from meter verifications of a sensor assembly 10.

FIG. 7 shows an energy dissipation-viscosity relationship plot 700 for determining a viscosity of a fluid.

FIG. 8 shows a method 800 for determining a viscosity of a fluid.

FIG. 9 shows a method 900 for determining a viscosity of the fluid.

### DETAILED DESCRIPTION

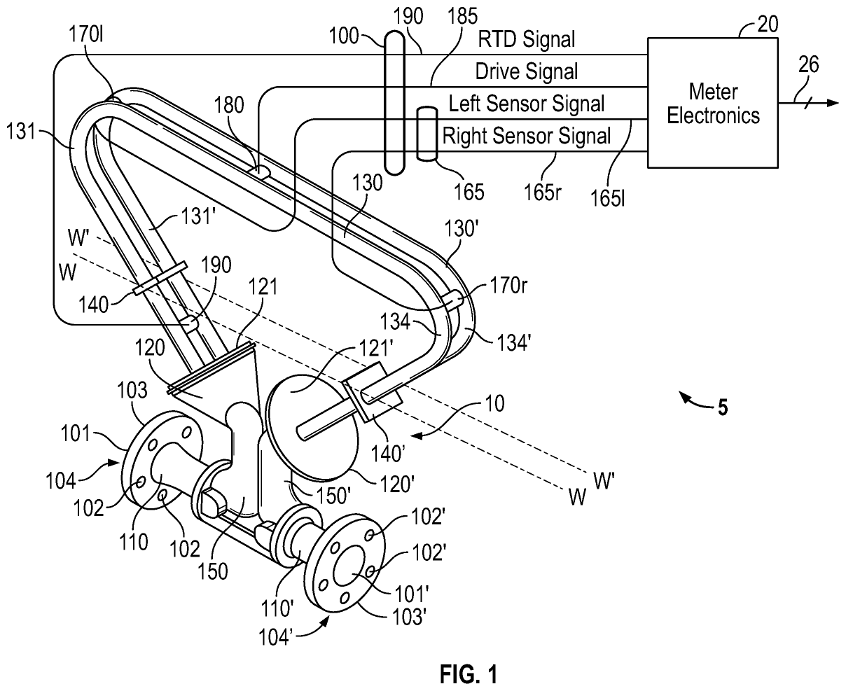

FIGS. 1-9 and the following description depict specific examples to teach those skilled in the art how to make and use the best mode of embodiments of determining a viscosity of a fluid. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of determining the viscosity of the fluid. As a result, the embodiments described below are not limited to the specific examples described below, but only by the claims and their equivalents.

FIG. 1 shows a vibratory meter 5 configured to determine a viscosity of a fluid. As shown in FIG. 1, the vibratory meter 5 comprises a sensor assembly 10 and meter electronics 20. The sensor assembly 10 responds to mass flow rate and density of a process material. The meter electronics 20 is connected to the sensor assembly 10 via leads 100 to provide density, mass flow rate, and temperature information over port 26, as well as other information.

The sensor assembly 10 includes a pair of manifolds 150 and 150′, flanges 103 and 103′ having flange necks 110 and 110′, a pair of parallel conduits 130 and 130′, driver 180, resistive temperature detector (RTD) 190, and a pair of pick-off sensors 1701 and 170r. Conduits 130 and 130′ have two essentially straight inlet legs 131, 131′ and outlet legs 134, 134′, which converge towards each other at conduit mounting blocks 120 and 120′. The conduits 130, 130′ bend at two symmetrical locations along their length and are essentially parallel throughout their length. Brace bars 140 and 140′ serve to define the axis W and W′ about which each conduit 130, 130′ oscillates. The legs 131, 131′ and 134, 134′ of the conduits 130, 130′ are fixedly attached to conduit mounting blocks 120 and 120′ and these blocks, in turn, are fixedly attached to manifolds 150 and 150′. This provides a continuous closed material path through sensor assembly 10.

When flanges 103 and 103′, having holes 102 and 102′ are connected, via inlet end 104 and outlet end 104′ into a process line (not shown) which carries the process material that is being measured, material enters inlet end 104 of the meter through an orifice 101 in the flange 103 and is conducted through the manifold 150 to the conduit mounting block 120 having a surface 121. Within the manifold 150 the material is divided and routed through the conduits 130, 130′. Upon exiting the conduits 130, 130′, the process material is recombined in a single stream within the block 120′ having a surface 121′ and the manifold 150′ and is thereafter routed to outlet end 104′ connected by the flange 103′ having holes 102′ to the process line (not shown).

The conduits 130, 130′ are selected and appropriately mounted to the conduit mounting blocks 120, 120′ so as to have substantially the same mass distribution, moments of inertia and Young's modulus about bending axes W-W and W′-W′, respectively. These bending axes go through the brace bars 140, 140′. Inasmuch as the Young's modulus of the conduits change with temperature, and this change affects the calculation of flow and density, RTD 190 is mounted to conduit 130′ to continuously measure the temperature of the conduit 130′. The temperature of the conduit 130′ and hence the voltage appearing across the RTD 190 for a given current passing therethrough is governed by the temperature of the material passing through the conduit 130′. The temperature dependent voltage appearing across the RTD 190 is used in a well-known method by the meter electronics 20 to compensate for the change in elastic modulus of the conduits 130, 130′ due to any changes in conduit temperature. The RTD 190 is connected to the meter electronics 20 by lead 195.

Both of the conduits 130, 130′ are driven by driver 180 in opposite directions about their respective bending axes W and W′ and at what is termed the first out-of-phase bending mode of the vibratory meter. This driver 180 may comprise any one of many well-known arrangements, such as a magnet mounted to the conduit 130′ and an opposing coil mounted to the conduit 130 and through which an alternating current is passed for vibrating both conduits 130, 130′. A suitable drive signal 185 is applied by the meter electronics 20, via a lead, to the driver 180.

The meter electronics 20 receives the RTD temperature signal on lead 195, and sensor signals 165 appearing on leads 100 carrying left and right sensor signals 1651, 165r, respectively. The meter electronics 20 produces the drive signal 185 appearing on the lead to driver 180 and vibrate conduits 130, 130′. The meter electronics 20 processes the left and right sensor signals 1651, 165r and the RTD signal on lead 195 to compute the mass flow rate and the density of the material passing through sensor assembly 10. This information, along with other information, is applied by meter electronics 20 over port 26 as a signal. A more detailed discussion of the meter electronics 20 follows.

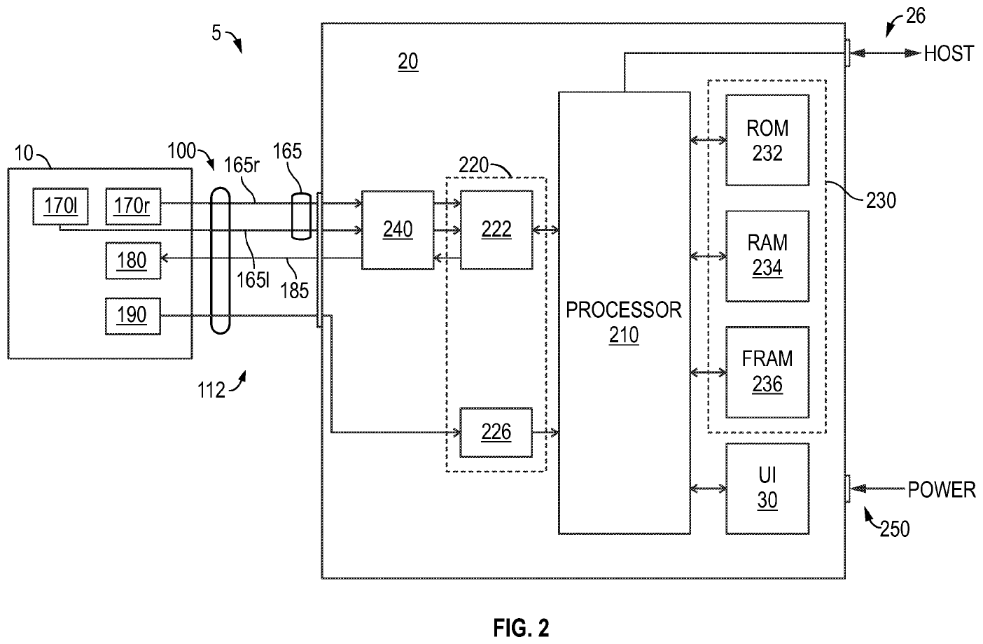

FIG. 2 shows a block diagram of the vibratory meter 5, including a block diagram representation of the meter electronics 20, configured to determine a viscosity of a fluid. As shown in FIG. 2, the meter electronics 20 is communicatively coupled to the sensor assembly 10. As described in the foregoing with reference to FIG. 2, the sensor assembly 10 includes the left and right pick-off sensors 1701, 170r, driver 180, and RTD 190, which are communicatively coupled to the meter electronics 20 via the set of leads 100 through a communications channel 112.

The meter electronics 20 provides a drive signal 185 via the leads 100. More specifically, the meter electronics 20 provides a drive signal 185 to the driver 180 in the sensor assembly 10. In addition, sensor signals 165 comprising the left sensor signal 1651 and the right sensor signal 165r are provided by the sensor assembly 10. More specifically, in the embodiment shown, the sensor signals 165 are provided by the left and right pick-off sensor 1701, 170r in the sensor assembly 10. As can be appreciated, the sensor signals 165 are respectively provided to the meter electronics 20 through the communications channel 112.

The meter electronics 20 includes a processor 210 communicatively coupled to one or more signal processors 220 and one or more memories 230. The processor 210 is also communicatively coupled to a user interface 30. The processor 210 is communicatively coupled with the host via a communication port over the port 26 and receives electrical power via an electrical power port 250. The processor 210 may be a microprocessor although any suitable processor may be employed. For example, the processor 210 may be comprised of sub-processors, such as a multi-core processor, serial communication ports, peripheral interfaces (e.g., serial peripheral interface), on-chip memory, I/O ports, and/or the like. In these and other embodiments, the processor 210 is configured to perform operations on received and processed signals, such as digitized signals.

The processor 210 may receive digitized sensor signals from the one or more signal processors 220. The processor 210 is also configured to provide information, such as a phase difference, a property of a fluid in the sensor assembly 10, or the like. The processor 210 may provide the information to the host through the communication port. The processor 210 may also be configured to communicate with the one or more memories 230 to receive and/or store information in the one or more memories 230. For example, the processor 210 may receive calibration factors and/or sensor assembly zeros (e.g., phase difference when there is zero flow) from the one or more memories 230. Each of the calibration factors and/or sensor assembly zeros may respectively be associated with the vibratory meter 5 and/or the sensor assembly 10. The processor 210 may use the calibration factors to process digitized sensor signals received from the one or more signal processors 220.

The one or more signal processors 220 is shown as being comprised of an encoder/decoder (CODEC) 222 and an analog-to-digital converter (ADC) 226. The one or more signal processors 220 may condition analog signals, digitize the conditioned analog signals, and/or provide the digitized signals. The CODEC 222 is configured to receive the sensor signals 165 from the left and right pick-off sensors 1701, 170r. The CODEC 222 is also configured to provide the drive signal 185 to the driver 180. In alternative embodiments, more or fewer signal processors may be employed.

As shown, the sensor signals 165 are provided to the CODEC 222 via a signal conditioner 240. The drive signal 185 is provided to the driver 180 via the signal conditioner 240. Although the signal conditioner 240 is shown as a single block, the signal conditioner 240 may be comprised of signal conditioning components, such as two or more op-amps, filters, such as low pass filters, voltage-to-current amplifiers, or the like. For example, the sensor signals 165 may be amplified by a first amplifier and the drive signal 185 may be amplified by the voltage-to-current amplifier. The amplification can ensure that the magnitude of the sensor signals 165 is approximate the full-scale range of the CODEC 222.

In the embodiment shown, the one or more memories 230 is comprised of a read-only memory (ROM) 232, random access memory (RAM) 234, and a ferroelectric random-access memory (FRAM) 236. However, in alternative embodiments, the one or more memories 230 may be comprised of more or fewer memories. Additionally, or alternatively, the one or more memories 230 may be comprised of different types of memory (e.g., volatile, non-volatile, etc.). For example, a different type of non-volatile memory, such as, for example, erasable programmable read only memory (EPROM), or the like, may be employed instead of the FRAM 236. The one or more memories 230 may be a storage configured to store process data, such as drive or sensor signals, mass flow rate or density measurements, etc.

A mass flow rate measurement can be generated according to the equation:

$$\dot{m} = FCF [ Δ t - Δ {t}_{0} ] ; \qquad [ 1 ]$$

where:
\dot{m} is a measured mass flow rate;
FCF is a flow calibration factor;
Δt is a measured time delay; and
Δt₀ is a zero-flow time delay.

The measured time delay Δt comprises an operationally-derived (i.e., measured) time delay value comprising the time delay existing between the pickoff sensor signals, such as where the time delay is due to Coriolis effects related to mass flow rate through the vibratory meter 5. The measured time delay Δt is a direct measurement of a mass flow rate of the flow material as it flows through the vibratory meter 5. The zero-flow time delay Δt₀ comprises a time delay at a zero flow. The zero-flow time delay Δt₀ is a zero-flow value that may be determined at the factory and programmed into the vibratory meter 5. The zero-flow time delay Δt₀ is an exemplary zero-flow value. Other zero-flow values may be employed, such as a phase difference, time difference, or the like, that are determined at zero flow conditions. A value of the zero-flow time delay Δt₀ may not change, even where flow conditions are changing. A mass flow rate value of the material flowing through the vibratory meter 5 is determined by multiplying a difference between measured time delay Δt and a reference zero-flow value Δt₀ by the flow calibration factor FCF. The flow calibration factor FCF is proportional to a physical stiffness of the vibratory meter.

As to density, a resonance frequency at which each conduit 130, 130′ may vibrate may be a function of the square root of a spring constant of the conduit 130, 130′ divided by the total mass of the conduit 130, 130′ which may have a material inside. The total mass of the conduit 130, 130′ which may have a material inside may be a mass of the conduit 130, 130′ plus a mass of a material inside the conduit 130, 130′. The mass of the material in the conduit 130, 130′ is directly proportional to the density of the material. Therefore, the density of this material may be proportional to the square of a period at which the conduit 130, 130′ containing the material oscillates multiplied by the spring constant of the conduit 130, 130′. Hence, by determining the period at which the conduit 130, 130′ oscillates and by appropriately scaling the result, an accurate measure of the density of the material contained by the conduit 130, 130′ can be obtained. The meter electronics 20 can determine the period or resonance frequency using one or more of the sensor signals 165 and/or the drive signal 185. The conduits 130, 130′ may oscillate with more than one vibration mode.

The vibrational response of a flow meter can be represented by an open loop, second order drive model, comprising:

$$M \ddot{x} + C \dot{x} + Kx = f ( t ) \qquad [ 2 ]$$

where f(t) is the force applied to the system, M is a mass parameter of the system, C is a damping parameter, and K is a stiffness parameter. The term x is the physical displacement distance of the vibration, the term x is the velocity of the conduit displacement, and the term x is the acceleration. This is commonly referred to as the MCK model. This formula can be rearranged into the form:

$$( {ms}^{2} + cs + k ) X ( s ) = F ( s ) + ( ms + c ) x ( 0 ) + m \dot{x} ( 0 ) \qquad [ 3 ]$$

Equation [3] can be further manipulated into a transfer function form, while ignoring the initial conditions. The result is:

$$H ( s ) = \frac{output}{input} = \frac{X ( s )}{F ( s )} = \frac{\frac{1}{m}}{{s}^{2} + \frac{c}{m} s + \frac{k}{m}} \qquad [ 4 ]$$

Further manipulation can transform equation [4] into a first order pole-residue frequency response function form, comprising:

$$H ( v ) = \frac{R}{( j ω - λ )} + \frac{\overline{R}}{( j ω - \overline{λ )}} \qquad [ 5 ]$$

where λ is the pole, R is the residue, the term j comprises the square root of −1, and ω is the circular excitation frequency in radians per second.

The system parameters comprising the natural/resonant frequency ωₙ, the damped natural frequency ω_{d}, and the damping ratio (are defined by the pole.

$${ω}_{n} = \vert λ \vert \qquad [ 6 ]$$

$${ω}_{d} = imag ( λ ) \qquad [ 7 ]$$

$$ζ = \frac{real ( λ )}{{ω}_{n}} \qquad [ 8 ]$$

The stiffness parameter K, the damping parameter C, and the mass parameter M of the system can be derived from the pole and residue.

$$M = \frac{1}{2 jR {ω}_{d}} \qquad [ 9 ]$$

$$K = {ω}_{n}^{2} M \qquad [ 10 ]$$

$$C = 2 {ζω}_{n} M \qquad [ 11 ]$$

Consequently, the stiffness parameter K, the mass parameter M, and the damping parameter C can be calculated based on a good estimate of the pole λ and the residue R. The pole and residue can be estimated from the measured frequency response functions. The pole λ and the residue R can be estimated using an iterative computational method, for example.

Due to changes in stiffness of the conduits, such as the conduits 130, 130′ described above, a mass flow rate m measurement and a density ρ measurement may vary over time even if the mass flow rate m and density ρ of the material remains constant. For example, if a temperature of the conduits increases, then the conduits' stiffness may correspondingly decrease. This decrease in stiffness may change the time delay Δt (or phase difference) between the sensor signals provided by the left and right pickoff sensors. This decrease in stiffness may also change a resonance frequency of the conduits.

Similarly, a variation in damping due to the conduits 130, 130′ containing the fluid may also cause a change in the mass flow rate m measurement and a density ρ measurement. That is, the damping may be due to various energy dissipation characteristics, such as material damping of the conduits 130, 130′ themselves, energy dissipation of the fluid contained by the conduits 130, 130′, material damping in the brace bars 140, 140′, air energy dissipation of air around the conduits 130, 130′, etc. Any change to these sources of energy dissipation can cause a change in the measured flow rate, density, etc.

However, as can be appreciated from the foregoing discussion, if the sensor assembly 10 itself does not change, then the only source of variation in the energy dissipation of the conduits 130, 130′ containing the material is the material contained by the conduits. For example, the material damping properties of the conduits 130, 130′, brace bars 140, 140, etc., of the sensor assembly 10 are not expected to change in a relatively short period of time. Accordingly, a change in the damping value over an extended period where a change in the sensor assembly 10 is not expected (e.g., due to a reference fluid being used) but could occur and such a change can be attributed to a change in the material damping of the conduits 130, 130′.

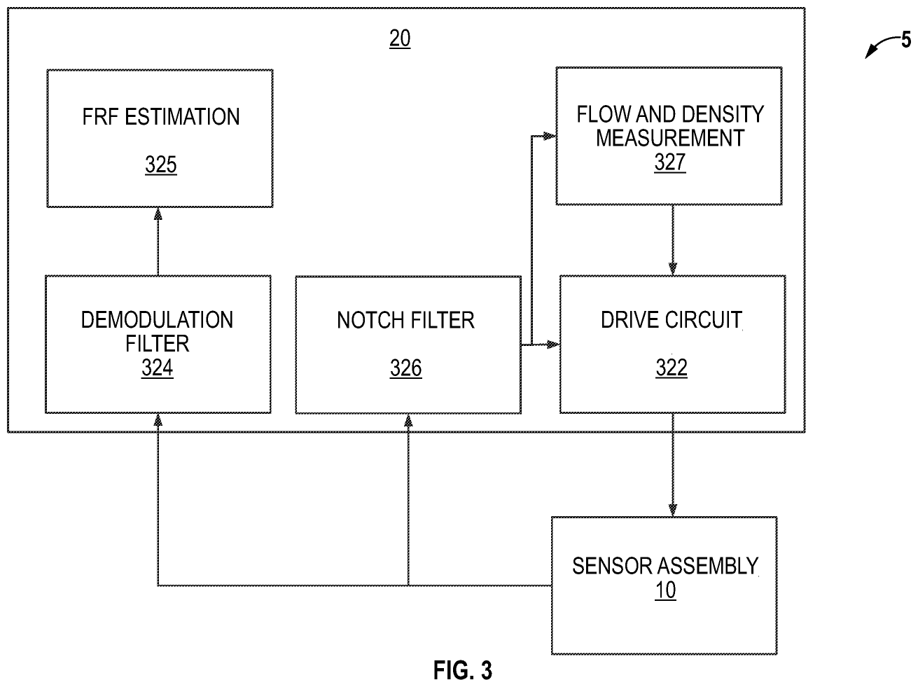

Various characteristics, including an energy dissipation value, of the conduit containing the fluid can be determined by utilizing various techniques. In one exemplary technique, characteristics of a sensor assembly, such as the sensor assembly 10 described above, may be determined using one or more of the sensor signals from the sensor assembly. The characteristics, including the energy dissipation value, can be determined by providing a drive signal with a resonance frequency component and several non-resonance frequency components. The sensor assembly may vibrate in response to these resonance and non-resonance frequency components. Accordingly, the pickoff sensors may provide sensor signals that each are comprised of resonance and non-resonance frequency components that respectively correspond to the resonance and non-resonance components of the drive signal. These resonance and non-resonance components of the one or more sensor signals can be filtered by a processing system to determine a fluid property value (e.g., density value) and a current stiffness value, as is described in more detail in the following with reference to FIG. 3.

FIG. 3 shows a block diagram of the vibratory meter 5 with a frequency response function estimation for determining a viscosity of a fluid. As shown in FIG. 3, the vibratory meter 5 includes the sensor assembly 10 and the meter electronics 20 communicatively coupled to the sensor assembly 10. The meter electronics 20 is configured to provide a multi-tone drive signal to the sensor assembly 10. The sensor assembly 10 provides sensor signals to the meter electronics 20. The meter electronics includes a drive circuit 322 and a demodulation filter 324 that are communicatively coupled to the sensor assembly 10. The demodulation filter 324 is communicatively coupled to a frequency response function (FRF) estimation unit 325. A notch filter 326 is communicatively coupled to the drive circuit 322 and a flow and density measurement module 327. The notch filter signal is provided to the flow and density measurement module 327 to determine the flow rate and/or density of the fluid in the vibratory meter 5.

The drive circuit 322 receives a resonant component of the sensor signal from the notch filter 326. The drive circuit 322 is configured to generate a multi-tone drive signal for the sensor assembly 10. The multi-tone drive signal is comprised of a drive tone and test tones. The drive tone is based on the resonant component provided by the notch filter 326. For example, the drive circuit 322 may include a feedback circuit that receives the resonant component and generates the drive tone by amplifying the resonant component. Other methods may be employed. The drive circuit 322 can also generate the test tones at predetermined frequencies that are spaced apart from the resonant frequency.

The demodulation filter 324 receives the sensor signal from the sensor assembly and filters out intermodulation distortion signals that may be present in the sensor signal. For example, the drive tone and test tones in the multi-tone drive signal may induce intermodulation distortion signals in the sensor signals provided by the sensor assembly 10. To filter out the intermodulation distortion signals, the demodulation filter 324 may include demodulation windows or passbands that include the frequencies of the drive tone and the test tones. Accordingly, the demodulation filter 324 provides one or more sensor signals comprised of the resonance components and non-resonance components that correspond to the test tones, while preventing the intermodulation distortion signals from corrupting, for example, a meter verification of the sensor assembly 10. The meter verification is performed using the FRF estimation unit 325, which compares the components corresponding to the drive tone and the test tones to characterize the frequency response of the sensor assembly.

The notch filter 326 is used during meter verification. Accordingly, the notch filter 326 may not be switched in during normal flow and density measurement. Due to fairly large frequency changes in normal operation, coefficients of the notch filter 326 coefficients may need to be frequently calculated and updated, which results in additional computational load and possible unwanted transients. Instead, when meter verification is utilized, the drive tone is sampled to determine the carrier frequency and the coefficients of the notch filter 326 are calculated based on the determined carrier frequency. The notch filter 326 is then switched in and the test tones are ramped to desired amplitude. During meter verification, the carrier frequency may be monitored and if a difference between the determined carrier frequency (determined during the sampling of the drive tone as described above) and the carrier frequency during meter verification is greater than a threshold, then the meter verification may be terminated by, for example, switching out the notch filter 326 and turning off the test tones.

To filter out the sensor signal components, the notch filter 326 includes a plurality of stop bands centered at or about the frequencies of the test tones. The sensor signal components are attenuated or filtered out due to being centered at or about the frequencies of the stop bands. The resonant signal is passed due to being in the pass band of the notch filter 326. Alternatively, the energy dissipation value of the sensor assembly may be determined prior to the one or more sensor signals being provided for a fluid property measurement. For example, a meter verification routine may be performed prior to a material being measured in the sensor assembly. This may not require filtering out the resonance component of the one or more sensor signals.

Information obtained from the one or more sensor signals may be used to determine a viscosity of a fluid contained by a sensor assembly. For example, a meter electronics communicatively coupled to the sensor assembly containing the fluid may be configured to determine the viscosity of the fluid contained by the sensor assembly, such as the meter electronics 20 described above, and discussed in more detail in the following.

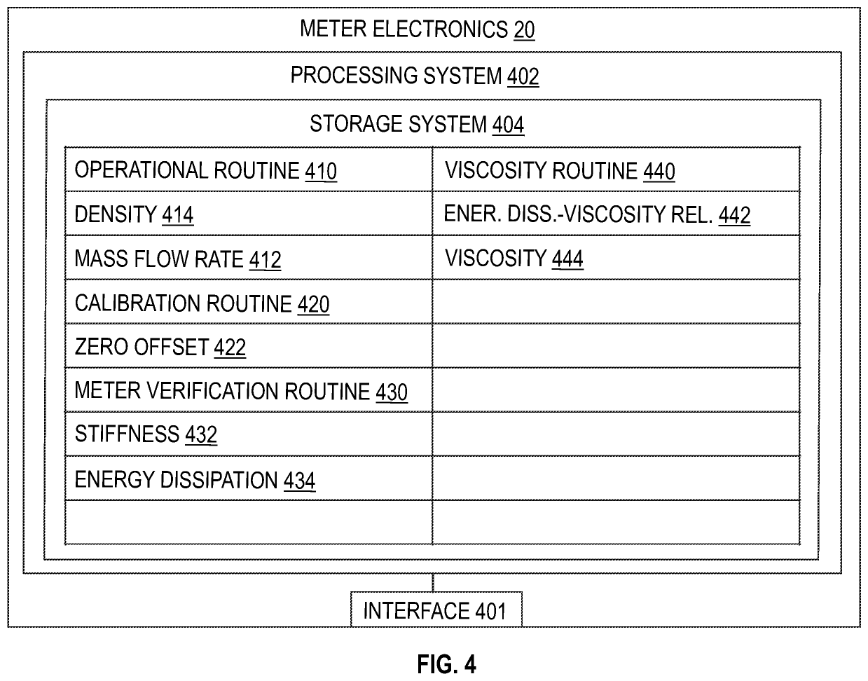

FIG. 4 shows a meter electronics 20 for determining a viscosity of a fluid. As shown in FIG. 4, the meter electronics 20 includes an interface 401 and a processing system 402. The meter electronics 20 receives a vibrational response from a sensor assembly, such as the sensor assembly 10 described above, for example. The meter electronics 20 processes the vibrational response in order to obtain flow properties of the flow material flowing through the sensor assembly 10. The meter electronics 20 may also perform checks, verifications, calibration routines, or the like, to ensure the fluid flow parameters of the flow material are accurately measured.

The interface 401 may receive the sensor signals 165 from one of the pick-off sensors 1701, 170r shown in FIGS. 1 and 2. The interface 401 can perform any necessary or desired signal conditioning, such as any manner of formatting, amplification, buffering, etc. Alternatively, some or all of the signal conditioning can be performed in the processing system 402. In addition, the interface 401 can enable communications between the meter electronics 20 and external devices. The interface 401 can be capable of any manner of electronic, optical, or wireless communication. The interface 401 can provide information based on the vibrational response. The interface 401 may be coupled with a digitizer, such as the CODEC 222 shown in FIG. 2, wherein the sensor signal comprises an analog sensor signal. The digitizer samples and digitizes an analog sensor signal and produces a digitized sensor signal.

The processing system 402 conducts operations of the meter electronics 20 and processes flow measurements from the sensor assembly 10. The processing system 402 executes one or more processing routines and thereby processes the flow measurements in order to produce one or more flow properties. The processing system 402 is communicatively coupled to the interface 401 and is configured to receive the information from the interface 401.

The processing system 402 can comprise a general-purpose computer, a micro-processing system, a logic circuit, or some other general purpose or customized processing device. Additionally, or alternatively, the processing system 402 can be distributed among multiple processing devices. The processing system 402 can also include any manner of integral or independent electronic storage medium, such as the storage system 404.

The storage system 404 can store vibratory meter parameters and data, software routines, constant values, and variable values. In one embodiment, the storage system 404 includes routines that are executed by the processing system 402, such as an operational routine 410 of the vibratory meter 5. The storage system can also store statistical values, such as a mean, standard deviation, confidence interval, etc., or the like.

The operational routine 410 may determine a mass flow rate value 412 and a density value 414 based on the sensor signals received by the interface 401. The mass flow rate value 412 may be determined from the sensor signals, such as a time delay between a left pickoff sensor signal and a right pickoff sensor signal. The density value 414 may also be determined from the sensor signals by, for example, determining a frequency from one or both of the left and right pickoff sensor signals.

As shown in FIG. 4, the storage system 404 also includes a calibration routine 420. The calibration routine 420 may determine a zero offset 422 of the sensor assembly. With more particularity, the calibration routine 420 may determine a time delay (or phase difference) between the right and left pickoff sensor signals when there is zero flow through the sensor assembly. The time delay at zero flow may be stored in the storage system 404 as the zero offset 422, which may be the zero-flow time delay Δt₀ of above equation [1].

The storage system 404 shown in FIG. 4 further includes a meter verification routine 430. The meter verification routine 430 may determine one or more sensor assembly properties, such as conduit material properties. The meter properties may be determined by providing a drive signal that includes a resonant frequency component and one or more off-resonant frequency components. The sensor signals may therefore include components that correspond to the resonant frequency component and the one or more off-resonant frequency components. A transfer function between the drive signal's one or more off-resonant frequency components and the sensor signal's one or more off-resonant frequency components can be used to determine the material properties of the sensor signals. As shown in FIG. 4, the sensor assembly properties include a stiffness 432, and an energy dissipation 434, although additionally or alternatively, other sensor assembly properties may be employed.

The stiffness 432 may comprise or include a stiffness of a conduit, such as the conduits 130, 130′ discussed above, between a left pickoff and a right pickoff, although any suitable stiffness may be stored. For example, additionally or alternatively, the stiffness 432 may include a left stiffness between a left pickoff and the driver and a right stiffness between a right pickoff and the driver. Similarly, the energy dissipation 434 may comprise or include a material damping of the sensor assembly, such as the sensor assembly 10 discussed above, energy dissipation of the material contained by one or more conduits of the sensor assembly, air damping of the air around the conduits, etc. The energy dissipation 434 may be comprised of an energy dissipation of the conduit between the left and right pickoff sensors, between the left pickoff sensor and the driver, and/or the right pickoff sensor and the driver.

Different fluids having different viscosities may result in a change in an energy dissipation 434 of a sensor assembly. This change in energy dissipation 434 of the sensor assembly can be correlated with a viscosity of the fluid. For example, a measured stiffness 432 of the sensor assembly may remain relatively constant regardless of the viscosities of the different fluids contained by the one or more conduits of the sensor assembly. However, the energy dissipation 434 may be correlated with the viscosities of the various fluids.

Accordingly, the storage system 404 is shown in FIG. 4 as also including a viscosity routine 440. The viscosity routine 440 may employ an energy dissipation-viscosity relationship 442 to determine a viscosity 444 of a fluid contained within a conduit. With more particularity, and as will be described in more detail in the following, the energy dissipation 434 may be used by the viscosity routine 440 as an independent variable in the energy dissipation-viscosity relationship 442 to determine the viscosity 444. The following discussion illustrates an exemplary energy dissipation-viscosity relationship 442 that may be used to determine a viscosity of a fluid from a measured energy dissipation 434.

### Stiffness Measurements

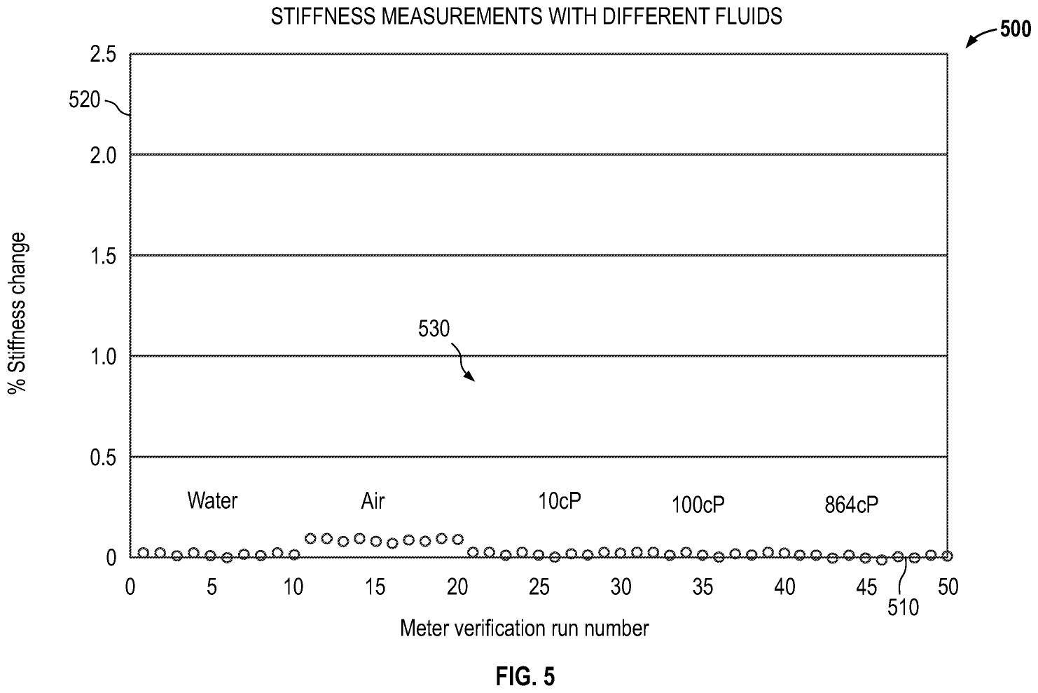

FIG. 5 shows a stiffness measurement change plot 500 from meter verifications of a sensor assembly 10. As shown in FIG. 5, the stiffness measurement change plot 500 includes a meter verification run number axis 510 and a percent stiffness change axis 520, although any suitable axes may be employed. The meter verification run number axis 510 represents a given run of a series of discrete meter verification runs or tests and the percent stiffness change axis 520 represents a change in a measured stiffness value relative to a reference stiffness value. The stiffness measurement change plot 500 also includes stiffness measurement change values 530 that respectively correspond to meter verification runs.

The stiffness measurement change values 530 have four groups of stiffness measurement change values. Each of the four groups are associated and labeled with a corresponding fluid that is contained by a sensor assembly, such as the sensor assembly described above, during the corresponding meter verification runs. The four groups are labeled “water”, “air”, “10 cP”, “100 cP”, and “864 cP”. Accordingly, for example, the group of stiffness measurement change values 530 labeled “water” correspond to stiffness values obtained when the sensor assembly contains water. The groups of stiffness measurement values labeled “10 cP”, “100 cP”, and “864 cP” respectively correspond to fluids that have a viscosity value of, respectively, 10 centipoise (cP), 100 cP, and 864 cP.

As can be appreciated from the stiffness measurement change values 530, water has little to no change relative to a baseline stiffness measurement value. As can also be appreciated, when the sensor assembly contains “10 cP”, “100 cP”, and “864 cP” fluids, there is similarly very little change in the stiffness measurement value relative to the baseline stiffness measurement value. There is some change in the stiffness measurement value when the sensor assembly contains air. However, the stiffness measurement change value for “air” is less than 0.5 percent relative to the baseline stiffness measurement value.

The following demonstrates significantly more variation in energy dissipation values of the sensor assembly when fluids of differing viscosity values are contained by the conduits during meter verification runs.

### Energy Dissipation Measurements

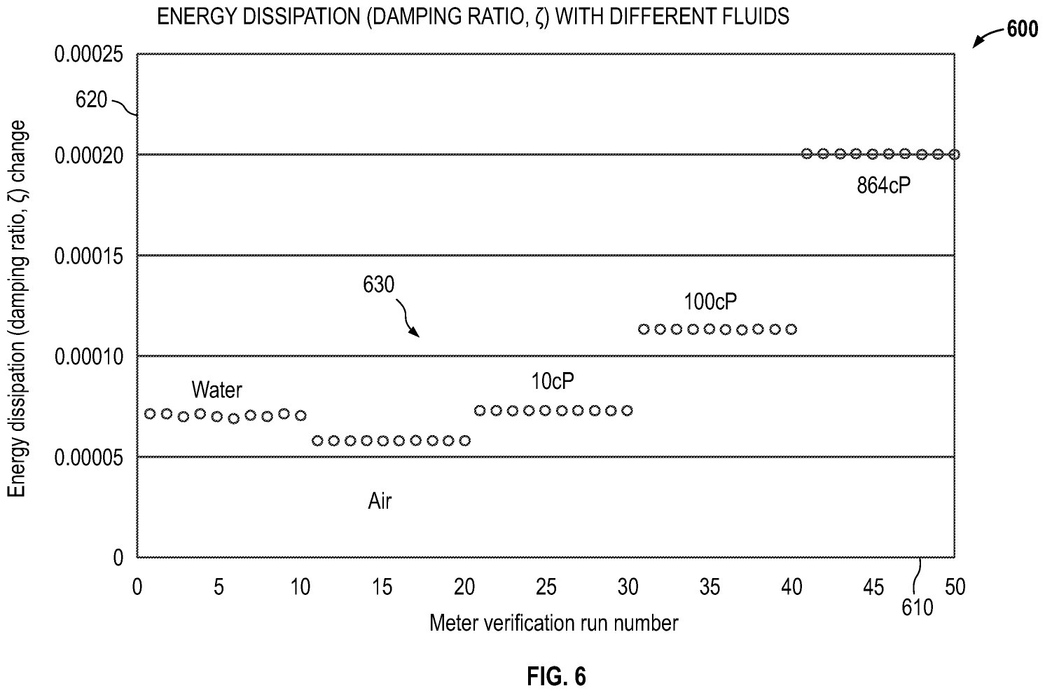

FIG. 6 shows energy dissipation change plot 600 from meter verifications of a sensor assembly. As shown in FIG. 6, the energy dissipation change plot 600 includes a meter verification run number axis 610 and an energy dissipation change axis 620. As shown in FIG. 6, the energy dissipation change axis 620 is a damping ratio of the sensor assembly, such as the sensor assembly 10 described above. The meter verification run number axis 610 represents a given run of a series of discrete meter verification runs or tests and the energy dissipation change axis 620 represents a change in a measured energy dissipation value relative to a reference or baseline energy dissipation value. As shown in FIG. 6, the energy dissipation value is a damping value based on a damping ratio comprising a measured or actual damping relative to a critical damping. However, any suitable parameter may be employed. The energy dissipation change plot 600 also includes energy dissipation change values 630 that respectively correspond to meter verification runs.

The energy dissipation change values 630 have five groups of energy dissipation measurement change values. Each of the five groups are associated and labeled with a corresponding fluid that is contained by a sensor assembly, such as the sensor assembly described above, during the corresponding meter verification runs. The five groups are labeled “water”, “air”, “10 cP”, “100 cP”, and “864 cP”. Accordingly, for example, the group of energy dissipation change values 630 labeled “water” correspond to energy dissipation values obtained when the sensor assembly contains water. The groups of energy dissipation measurement values labeled “10 cP”, “100 cP”, and “864 cP” correspond to fluids that have a viscosity value of, respectively, 10 cP, 100 cP, and 864 cP.

As can be appreciated from the energy dissipation change plot 600, there is variation between the energy dissipation change values 630 depending on the viscosity of the fluid contained by the conduits of the sensor assembly. For example, the groups of the energy dissipation change values 630 that correspond to water, air, and 10 cP are within about a 0.00005 and a 0.00007 change in energy dissipation value relative to the baseline energy dissipation value. However, the 100 cP and the 864 cP fluids respectively have about a 0.00012 and a 0.00020 energy dissipation change value. Additionally, because air and water respectively have viscosity values of about 0.0200 cP and 1.00 cP, the energy dissipation value also increases in some proportion relative to the viscosity of the air, water, and 10 cP fluids.

Therefore, as can be appreciated, the energy dissipation change values 630 illustrate that, in general, the greater the viscosity the greater the energy dissipation change value. The energy dissipation change values 630 also illustrate that a proportionality constant may be present. Accordingly, as described in more detail in the following, it is possible to estimate a viscosity value from the energy dissipation values.

### Energy Dissipation-Viscosity Relationship

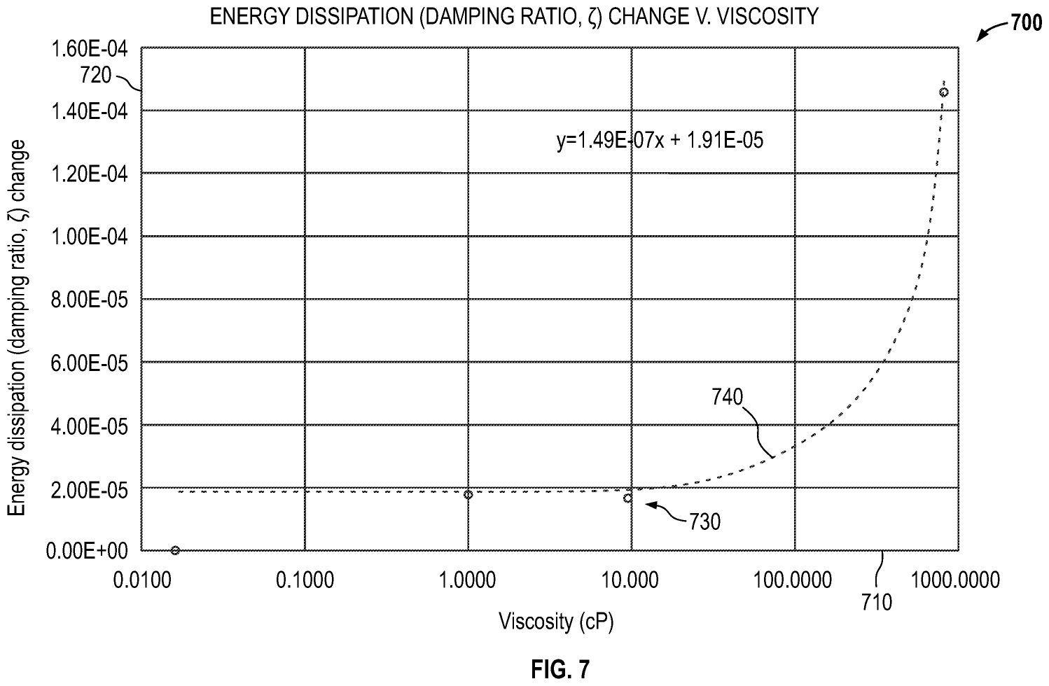

FIG. 7 shows an energy dissipation-viscosity relationship plot 700 for determining a viscosity of a fluid. As shown in FIG. 7, the energy dissipation-viscosity relationship plot 700 includes a viscosity axis 710 and an energy dissipation change axis 720. The viscosity axis 710 ranges from 0.0100 to 1000.0000 cP and the energy dissipation change axis 720 ranges from 0.00 to 1.60 E-04 although any suitable scale and units may be employed. As shown in FIG. 7, the energy dissipation change values are damping change values based on a damping ratio comprising a measured or actual damping relative to a critical damping. However, any suitable energy dissipation parameter may be employed, such as a decay characteristic, or the like. Also shown in FIG. 7 are energy dissipation-viscosity relationship values 730 and an energy dissipation-viscosity relationship equation 740.

The energy dissipation-viscosity relationship values 730 is comprised of a plurality of energy dissipation change values respective of a viscosity value of a fluid contained by one or more conduits of a sensor assembly, such as the conduits 130, 130′ described above. As shown in FIG. 7, the plurality of energy dissipation values are 0.00 E+00, 2.00 E-05, 2.00 E-05, and 1.45 E-04 for, respectively, viscosity values of about 0.0200, 1.000, 10.000, and 900.000 cP, although any suitable values, units, scaling, and/or the like may be employed.

The energy dissipation-viscosity relationship equation 740 may be determined by fitting a curve to the energy dissipation-viscosity relationship values 730. An exemplary method is linear regression, although any suitable method may be employed, including non-linear methods. As shown in FIG. 7, the energy dissipation-viscosity relationship equation 740 is y=1.49 E-07x+1.91 E-05, although any suitable equation can be employed. The energy dissipation-viscosity relationship equation 740 is depicted in FIG. 7 as a curve due to the logarithmic scale of the viscosity axis 710 although any suitable equation may be employed.

As can be appreciated from FIG. 7, an energy dissipation-viscosity relationship may be a set of ordered pairs, an equation, an algorithm, and/or any other suitable method that respectively relate a plurality of viscosity values to a plurality of energy dissipation values. For example, as is shown in the FIG. 7, the energy dissipation-viscosity relationship may be an equation. In an alternative example, the energy dissipation-viscosity relationship may be an algorithm that refers to a set of ordered pairs comprising energy dissipation and viscosity value pairs to interpolate an intermediate value between two ordered pairs.

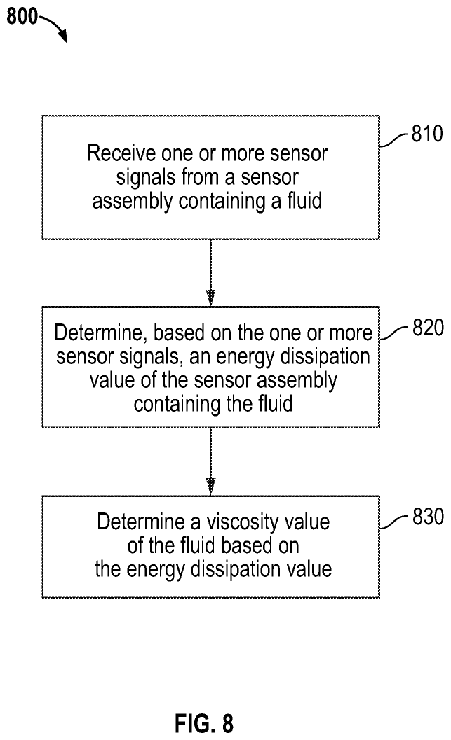

An energy dissipation-viscosity relationship, such as the energy dissipation-viscosity relationship equation 740 discussed above, may be used to determine a viscosity value from an energy dissipation value. For example, a variation in energy dissipation from a reference energy dissipation value that includes relatively small to no fluid damping may be correlated with viscosity values of various fluids. Accordingly, when a fluid having an unknown viscosity value is measured by a sensor assembly, such as the sensor assembly 10 discussed above, a damping value of the sensor assembly containing the fluid may be determined. A difference in damping value of the sensor assembly containing the fluid and a previously determined damping value of the sensor assembly containing, for example, air may be compared to a previously determined energy dissipation-viscosity relationship to determine the viscosity of the fluid, as is described in more detail in the following with reference to FIG. 8.

### Using a Previously Determined Energy Dissipation-Viscosity Relationship

FIG. 8 shows a method 800 for determining a viscosity of a fluid. As shown in FIG. 8, the method 800 receives sensor signals from a sensor assembly containing a fluid in step 810. For example, at least one conduit of the sensor assembly may contain the fluid. The sensor assembly employed by the method 800 may be the sensor assembly described above, although any suitable sensor assembly may be employed. One or more of the sensor signals may be used to determine a fluid property of the fluid, such as a non-viscosity fluid property, such as a density, a mass flow rate, or the like. In step 820, the method 800 determines, based on the one or more sensor signals, an energy dissipation value of the sensor assembly containing the fluid. The method 800, in step 830, determines a viscosity value of the fluid based on the energy dissipation value.

As discussed above, the energy dissipation value may be comprised of various forms of energy dissipation in the sensor assembly. The various forms of energy dissipation may include those associated with the sensor assembly itself, such as the conduits, brace bars, or the like, the environment, such as air drag on the conduits of the sensor assembly, and/or fluid damping. The energy dissipation may or may not be comprised of damping. Accordingly, the energy dissipation value may be a damping value of the sensor assembly. For example, the damping value of the sensor assembly may be comprised of at least a material damping of at least one conduit of the sensor assembly and a fluid damping of the fluid contained by the at least one conduit. Additionally, the damping value may be comprised of almost entirely the material damping of at least one conduit of the sensor assembly and the fluid damping of the fluid contained by the at least one conduit.

Accordingly, a damping value of a sensor assembly containing a relatively low viscosity fluid, such as air or other gas, may be almost entirely of a material damping of the one or more conduits of the sensor assembly. As can be appreciated, a damping value of a sensor assembly containing a viscous fluid, such as oil, will be greater than the damping value of the same sensor assembly containing the air. A difference in the damping value of the sensor assembly containing the oil and the damping value of the sensor assembly containing the air may be comprised entirely of a fluid damping of the oil.

Additionally, the one or more sensor signals received from the sensor assembly may be those that are used to determine a fluid property other than viscosity such as a mass flow rate, density, or the like. By way of illustration, a phase difference or time delay between the sensor signals can be used to determine a mass flow rate. The one or more sensor signals received from the sensor assembly may therefore not only be for determining the viscosity. The one or more sensor signals may measure a lateral displacement, such as a relative lateral displacement, between positions on one or more conduits and/or balance bars, or the like. Accordingly, receiving the sensor signals from the sensor assembly may comprise receiving a left pickoff sensor signal and a right pickoff sensor signal that measure a lateral displacement of one or more conduits of a sensor assembly.

Using the same one or more sensor signals to determine the density, mass flow rate, and viscosity of the fluid can eliminate the need for an additional sensor to sense a viscosity of the fluid. Other associated issues such as, for example, electrical crosstalk between viscosity determining circuit and a density/mass flow rate circuit may also be eliminated. Additionally, eliminating vibration modes, such as, for example, a torsion vibration mode dedicated to measuring viscosity may reduce noise due to vibration mode coupling. For example, the vibration mode coupling may not occur between the torsion mode and a twist mode used to determine a mass flow rate because the torsion mode is not present where the left and right pickoff sensor signals are used to determine a mass flow rate and a viscosity of the fluid.

As discussed above, the drive signal provided to the sensor assembly may be comprised of a drive tone and one or more test tones. The term “tone” may refer to a component of a signal, such as, for example, a drive signal, having a single frequency. The sensor signals received from the sensor assembly containing the fluid may accordingly comprise components that correspond to the drive tone and test tones. The drive tone is typically at a resonance frequency and the test tones are typically at unique non-resonance frequencies. Therefore, receiving the one or more sensor signals from the sensor assembly may comprise receiving a resonance frequency component and at least one non-resonance frequency component of the one or more sensor signals.

The method 800 may accordingly further comprise providing a drive signal to the sensor assembly and determining a drive signal value. As discussed above, the drive signal value may be used to determine an energy dissipation value. For example, determining the energy dissipation of the sensor assembly based on the one or more sensor signals may comprise determining a frequency response function based on the one or more sensor signals and the drive signal provided to the sensor assembly. Determining the frequency response function based on the one or more sensor signals and the drive signal provided to the sensor assembly may comprise determining a ratio of an amplitude of the one or more sensor signals and an amplitude of the drive signal.

As explained above, a viscosity value may be determined by using the energy dissipation value to obtain a correlated viscosity value. This may be accomplished by using an energy dissipation-viscosity relationship. For example, an energy dissipation-viscosity relationship may be an equation with an energy dissipation variable as an independent variable where the viscosity is a function of the energy dissipation variable. Additionally, or alternatively, a set of ordered pairs of energy dissipation values and viscosity values may be employed. Accordingly, determining the viscosity value of the fluid based on the energy dissipation value may comprise obtaining an energy dissipation-viscosity relationship and determining the viscosity value of the fluid based on the energy dissipation-viscosity relationship and the damping value.

As can be appreciated from the foregoing discussion, the energy dissipation-viscosity relationship may be obtained from a storage system in a meter electronics, such as the storage system 404 of the meter electronics 20 described above. Accordingly, the energy dissipation-viscosity relationship may be predetermined and stored in the meter electronics, as the following explains.

### Determining an Energy Dissipation-Viscosity Relationship

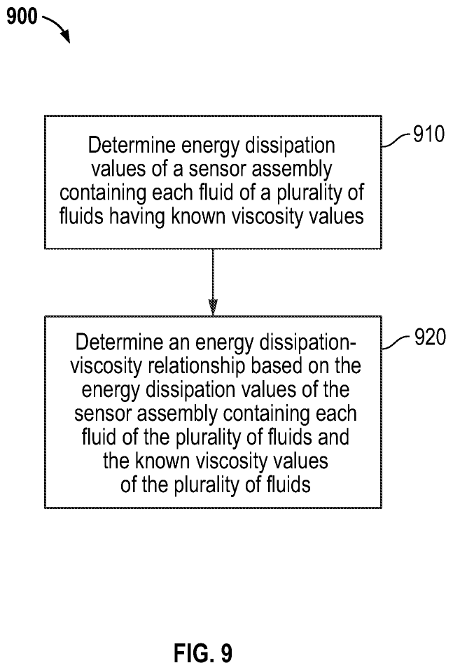

FIG. 9 shows a method 900 for determining a viscosity of the fluid. As shown in FIG. 9, the method 900 determines energy dissipation values of a sensor assembly containing each fluid of a plurality of fluids having known viscosity values in step 910. In step 920, the method 900 determines an energy dissipation-viscosity relationship based on the energy dissipation values of the sensor assembly containing each fluid of the plurality of fluids and the known viscosity values of the plurality of fluids.

Determining the energy dissipation-viscosity relationship may comprise determining a relation between the energy dissipation values of the sensor assembly containing each fluid of the plurality of fluids and the viscosity values of the plurality of fluids. For example, determining the relation between the energy dissipation values of the sensor assembly containing each fluid of the plurality of fluids and the viscosity values of the plurality of fluids may comprise determining at least one of a function and a set of ordered pairs that relate the energy dissipation values of the sensor assembly containing each fluid of the plurality of fluids and the viscosity values of the plurality of fluids. In one example, determining the energy dissipation-viscosity relationship based on the energy dissipation values of the sensor assembly containing each fluid of the plurality of fluids and the viscosity values of the plurality of fluids may comprise determining a second energy dissipation value of the second fluid in the one or more conduits of the sensor assembly and determining the energy dissipation-viscosity relationship based on at least the first fluid viscosity value, the first energy dissipation value, the second fluid viscosity value, and the second energy dissipation value.

As discussed in the foregoing, the energy dissipation value of the sensor assembly containing a fluid may be comprised of various energy dissipations in the sensor assembly and the fluid. For example, the energy dissipation may be comprised of a material damping of one or more conduits of the sensor assembly containing the fluid and a fluid damping of the fluid contained by the one or more conduits. Accordingly, each of the energy dissipation values of the sensor assembly containing each of the plurality of fluids represents an aggregate energy dissipation of the sensor assembly and a damping of each of the plurality of fluids contained by the sensor assembly.

As can be appreciated, the foregoing methods 800, 900 can be performed by a meter electronics, such as the meter electronics 20 described above. For example, the interface 401 may be configured to receive one or more sensor signals from a sensor assembly 10 containing the fluid and provide the one or more sensor signals. The one or more sensor signals provided by the interface may or may not be conditioned and/or digitized sensor signals. The processing system 402 communicatively coupled to the interface 401 may be configured to receive the one or more sensor signals from the interface 401 and perform the steps of above methods 800 and 900.

The vibratory meter 5, meter electronics 20, and methods 800, 900 described above can be used to determine a viscosity of a fluid. The one or more sensor signals used to determine the viscosity may also be used to determine other fluid properties, such as, for example, a mass flow, density, or the like of the fluid. For example, the one or more sensor signals used to determine the viscosity of the fluid may be provided by the left and right pick-off sensor 170, 170′ of the sensor assembly 10. As can be appreciated, because the left and right pick-off sensors 170, 170′ are used to determine a viscosity value of a fluid, additional sensors and other hardware as well as other driven vibration modes, such as torsional vibration modes, are not required.

Moreover, any suitable method able to determine an energy dissipation value of a sensor assembly containing a fluid may be employed. With more particularity, the energy dissipation value may be comprised of various sources of energy dissipation, but viscosity of a fluid contained by one or more conduits of a sensor assembly may be an only or dominant source of variation in the energy dissipation values, which may include energy dissipation change values. Accordingly, energy dissipation values of a sensor assembly containing the fluid may be accurately and correctly correlated with viscosity values of the fluid.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other vibratory meters, meter electronics, and methods for determining a viscosity of a fluid. Accordingly, the scope of the embodiments described above should be determined from the following claims.

We claim:

1. A method of determining a viscosity of a fluid, the method comprising:
receiving one or more sensor signals from a sensor assembly containing a fluid to determine a fluid property of the fluid;
determining, based on the one or more sensor signals, an energy dissipation value of the sensor assembly containing the fluid; and
determining a viscosity value of the fluid based on the energy dissipation value.

2. The method of claim 1, wherein the energy dissipation value is a damping value of the sensor assembly.

3. The method of claim 1, wherein the damping value of the sensor assembly is comprised of at least a material damping of at least one conduit of the sensor assembly and a fluid damping of the fluid contained by the at least one conduit.

4. The method of claim 1, wherein receiving the one or more sensor signals from the sensor assembly comprises receiving a left pickoff sensor signal and a right pickoff sensor signal.

5. The method of claim 1, wherein receiving the one or more sensor signals from the sensor assembly comprises receiving a resonance frequency component and at least one non-resonance frequency component of the one or more sensor signals.

6. The method of claim 1, further comprising providing a drive signal to the sensor assembly and determining a drive signal value.

7. The method of claim 6, wherein determining the energy dissipation value of the sensor assembly based on the one or more sensor signals comprises determining a frequency response function based on the one or more sensor signals and the drive signal provided to the sensor assembly.

8. The method of claim 7, wherein determining the frequency response function based on the one or more sensor signals and the drive signal provided to the sensor assembly comprises determining a ratio of an amplitude of the one or more sensor signals and an amplitude of the drive signal.

9. The method of claim 1, wherein determining the viscosity value of the fluid based on the energy dissipation value comprises obtaining an energy dissipation-viscosity relationship and determining the viscosity value of the fluid based on the energy dissipation-viscosity relationship and the energy dissipation value.

10. A meter electronics (20) for determining a viscosity of a fluid, the meter electronics (20) comprising:
an interface (401) configured to:
receive one or more sensor signals from a sensor assembly (10) containing the fluid; and
provide the one or more sensor signals; and
a processing system (402) communicatively coupled to the interface (401), the processing system (402) being configured to:
receive the one or more sensor signals from the interface (401); and
perform the steps of the foregoing claim 1.

11. A vibratory meter (5) for determining a viscosity of a fluid, the vibratory meter (5) comprising:
a sensor assembly (10) containing the fluid and configured to provide one or more sensor signals; and
a meter electronics (20) of the foregoing claim 10 communicatively coupled to the sensor assembly (10).

12. A method of determining a viscosity of a fluid, the method comprising:
determining energy dissipation values of a sensor assembly containing each fluid of a plurality of fluids having known viscosity values; and
determining an energy dissipation-viscosity relationship based on the energy dissipation values of the sensor assembly containing each fluid of the plurality of fluids and the known viscosity values of the plurality of fluids.

13. The method of claim 12, wherein determining the energy dissipation-viscosity relationship comprises determining a relation between the energy dissipation values of the sensor assembly containing each fluid of the plurality of fluids and the viscosity values of the plurality of fluids.

14. The method of claim 13, wherein the determining the relationship between the energy dissipation values of the sensor assembly containing each fluid of the plurality of fluids and the viscosity values of the plurality of fluids comprises determining at least one of a function and a set of ordered pairs that relate the energy dissipation values of the sensor assembly containing each fluid of the plurality of fluids and the viscosity values of the plurality of fluids.

15. The method of claim 12, wherein determining the energy dissipation-viscosity relationship based on the energy dissipation values of the sensor assembly containing each fluid of the plurality of fluids and the viscosity values of the plurality of fluids comprises:
determining a first energy dissipation value of a first fluid having a first viscosity value and a second energy dissipation value of the second fluid having a second viscosity value; and
determining the energy dissipation-viscosity relationship based on at least the first viscosity value, the first energy dissipation value, the second viscosity value, and the second energy dissipation value.

16. The method of claim 12, wherein each of the energy dissipation values of the sensor assembly containing each fluid of the plurality of fluids represents an aggregate energy dissipation of the sensor assembly and a damping of each of the plurality of fluids contained by the sensor assembly.

17. A meter electronics (20) for determining a viscosity of a fluid, the meter electronics (20) comprising:
an interface (401) configured to:
receive one or more sensor signals from a sensor assembly (10) containing the fluid; and
provide the one or more sensor signals; and
a processing system (402) communicatively coupled to the interface (401), the processing system (402) being configured to:
receive the one or more sensor signals from the interface (401); and
perform the steps of the foregoing claim 12.

18. A vibratory meter (5) for determining a viscosity of a fluid, the vibratory meter (5) comprising:
a sensor assembly (10) containing the fluid and configured to provide one or more sensor signals; and
a meter electronics (20) of the foregoing claim 17 communicatively coupled to the sensor assembly (10).
